(19) United States
(12) Patent Application Publication
(10) Pub. No.: US 2026/0364548 A1
(43) Pub. Date: Nov. 19, 2026

(54) Mixing Element for an Ink Container

(71) Applicant: Canon Production Printing Holding B.V., Venlo (NL)

(72) Inventors: Johannes Sturm, München (DE); Jochen Reinders, Isen (DE)

(21) Appl. No.: 19/677,025

(22) Filed: May 14, 2026

(30) Foreign Application Priority Data
May 15, 2025 (DE) 102025118752.5

(51) Int. Cl. B01F 27/1127; B01F 27/07; B01F 27/1125; B01F 27/906; B41J 2/175; B41J 2/20; B01F 101/35

(52) U.S. Cl. CPC B01F 27/1127; B01F 27/071; B01F 27/11251; B01F 27/906; B41J 2/17596; B41J 2/20; B01F 2101/35; B01F 2215/0422; B01F 2215/0431

(57) ABSTRACT

A mixing element is described for mixing ink that is arranged in an ink container of an ink supply system for an inkjet printing device. The mixing element includes a carrier that is designed to be rotated around a rotation axis, and at least one scoop attached to a support arm of the carrier. The scoop includes an intake opening through which ink is conducted into the scoop upon a rotation of the carrier, and an exit opening through which ink is conducted out of the scoop upon a rotation of the carrier. Furthermore, the scoop has an upper scoop wall that runs parallel to the support arm. Moreover, the scoop has a lower scoop wall that runs oblique to the support arm in the circumferential direction, so that the intake opening of the scoop has a larger cross-sectional area than the exit opening of the scoop.

### CROSS-REFERENCE TO RELATED APPLICATION

This application claims priority to German Patent Application No. 102025118752.5 filed May 15, 2025, the disclosure of which is hereby incorporated by reference in its entirety.

### BACKGROUND OF THE INVENTION

### Field of the Invention

The invention relates to an ink container for buffering ink for an inkjet printing device. In particular, the invention relates to a mixing element for an ink container.

### Description of Related Art

An inkjet printing device for printing to a recording medium can comprise a print bar having one or more print heads with respectively one or more nozzles. The nozzles are respectively configured to eject ink droplets in order to print dots of a print image on the recording medium. The individual print heads of a print bar are supplied with ink by an ink supply system, wherein the ink supply system typically has an ink container from which ink is provided for operation of the inkjet printing device.

### SUMMARY OF THE INVENTION

The present document deals with the technical object of providing a mixing element for an ink container via which a reliable provisioning of homogeneously designed ink is enabled for the operation of an inkjet printing device. The object is achieved via the features described herein.

According to one aspect, a mixing element is described for mixing ink that is arranged in an ink container of an ink supply system for an inkjet printing device. The mixing element comprises a carrier that is designed in order to be rotated around a rotation axis. Furthermore, the mixing element has at least one scoop attached to a support arm of the carrier, wherein the scoop is spaced apart from the rotation axis in the radial direction so that the scoop is directed around the rotation axis upon a rotation of the carrier in the circumferential direction.

The scoop has an intake opening via which ink is directed into the scoop upon a rotation of the carrier. Furthermore, the scoop has an exit opening via which ink is directed out of the scoop upon a rotation of the carrier. Moreover, the scoop comprises an upper scoop wall that preferably runs parallel to the support arm, as well as a lower scoop wall that preferably runs in a circumferential direction at an angle to the support arm, so that the intake opening of the scoop has a larger cross-sectional area than the exit opening of the scoop.

### BRIEF DESCRIPTION OF THE DRAWINGS

In the following, exemplary embodiments of the invention are described in detail using the schematic drawings. Thereby shown are:

FIG. 1 a block diagram of an example of an inkjet printing device;

FIG. 2 an example of an ink supply system for a print bar of an inkjet printing device;

FIGS. 3a-3c different views of an ink container having a mixing element;

FIG. 3d a lower detail of the ink container from FIG. 3a; and

FIGS. 4a-4c different views of an example of a mixing element with scoops.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

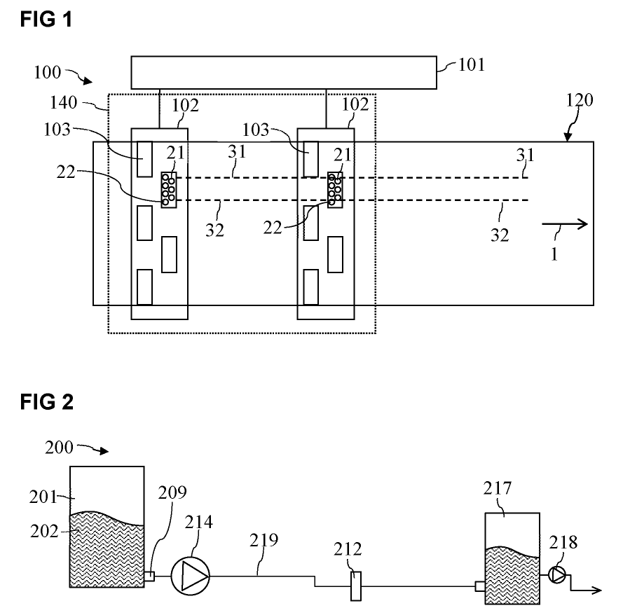

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is guided through the print group 140 of the printing device 100 along the transport direction 1, represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 typically comprises at least one fixing or drying unit that is not shown in FIG. 1 and that is configured to fix a print image printed on the recording medium 120.

A print bar 102 can comprise one or more print heads 103 that are possibly arranged side by side in a plurality of rows in order to print the dots of different columns 31, 32 of a print image onto the recording medium 120. In the example presented in FIG. 1, a print bar 102 comprises five print heads 103, wherein each print head 103 prints the dots of a group of columns 31, 32 of a print image onto the recording medium 120. The number of print heads 103 of a print bar 102 can be 5, 10, or more, for example.

In the embodiment depicted in FIG. 1, each print head 103 of the print group 140 comprises a plurality of nozzles 21, 22, wherein each nozzle 21, 22 is configured to fire or eject ink droplets onto the recording medium 120. For example, a print head 103 of the print group 140 can comprise multiple thousands of effectively utilized nozzles 21, 22 that are arranged along multiple rows transverse to the transport direction 1 of the recording medium 120. Dots of a line of a print image can be printed onto the recording medium 120 transverse to the transport direction 1, i.e. along the width of the recording medium 120, by means of the nozzles 21, 22 of a print head 103 of the print group 140.

The printing device 100 also comprises a control device 101, for example a driving hardware and/or a controller, that is configured to drive the actuators of the individual nozzles 21, 22 of the individual print heads 103 of the print group 140 in order to apply the print image onto the recording medium 120 depending on print data. In an exemplary embodiment, the control device 101 may include processing circuitry or at least one processor that is configured to perform one or more functions and/or operations of the control device 101, including activating the actuators of the individual nozzles 21, 22 of the individual print heads 103 of the print group 140 to apply the print image onto the recording medium 120 based on print data, processing print and/or other data, control one or more modes of the printing device 100 and/or controlling one or more operations of the printing device 100. In an exemplary embodiment, the control device 101 includes one or more interfaces (e.g. a wired and/or wireless input and/or output interface, transceiver, or the like) that are configured to receive or output data or information. For example, the control device 101 may receive signals generated by one or more components of the printing device 100 (e.g. from a user interface of the printing device 100) and/or output control signals to one or more components of the printing device 100. In an exemplary embodiment, the control device 101 may include a memory configured to store data/information, and/or store executable code that is executable by the processing circuitry to cause the processing circuitry or at least one processor to perform the operation(s) of the control device 101.

The print group 140 of the printing device 100 thus comprises at least one print bar 102 having K nozzles 21, 22 that can be arranged in one or more print heads and that can be driven with a defined line timing in order to print a respective line with K pixels or K columns 31, 32 of a print image onto the recording medium 120, for example with K > 1000, said line running transverse to the transport direction 1 of the recording medium 120. In the shown example, the nozzles 21, 22 are installed immobile or fixed in the printing device 100, and the recording medium 120 is directed past the stationary nozzles 21, 22 with a defined transport velocity.

FIG. 2 shows an example of an ink supply system 200 that is designed to supply the one or more print heads 103 of a print bar 102 of the printing device 100 with ink 212. The ink supply system 200 comprises an ink reservoir 201 that is designed to store ink 202, for example bag-in-the-box cardboard. The ink reservoir 201 can, for example, be designed to store and/or to accommodate 100 liters or more of ink 202. The ink 202 can be conducted out of the ink reservoir 201 via a connecting element 209 that, for example, is arranged at the floor of the ink reservoir 201. For this purpose, a conduit 219 can be connected at the connecting element 209 of the ink reservoir 201. A pump 214 can also be arranged at the conduit 219, which pump 214 is designed to pump ink 202 out of the ink reservoir 201.

The ink 202 drawn from the ink reservoir 201 can be conducted via the conduit 219 to an intermediate container 217, wherein the ink 202 can be pumped out of the intermediate container 217 to the one or more print heads 103 of the print bar 102 using an additional pump 218. A filter unit 212 can be arranged at the conduit 219, which filter unit 212 is designed to filter ink 202 taken from the ink reservoir 201 in order to filter contaminants and/or sediments out of the ink 202. It can thus be reliably avoided that the nozzles 21, 22 of the one or more print heads 103 of the print bar 102 clog due to contaminated ink 202.

The ink 202 supplied to the nozzles 21, 22 from the intermediate container 217, generally speaking from the ink container 217, should be designed to be optimally homogeneous, with an optimally consistent fraction of dye pigments and/or with an optimally uniform distribution of dye pigments. The ink 202 should also have no air inclusions. In this document, an ink container 217 and/or a mixing element for an ink container 217 are described that respectively enable homogeneous ink 202 without air inclusions to be provided efficiently and reliably in order to effect a consistently high print quality of an inkjet printing device 100.

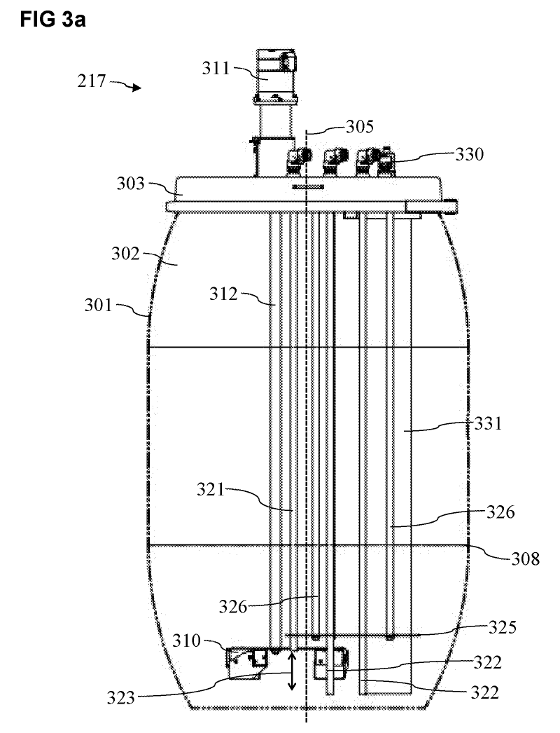

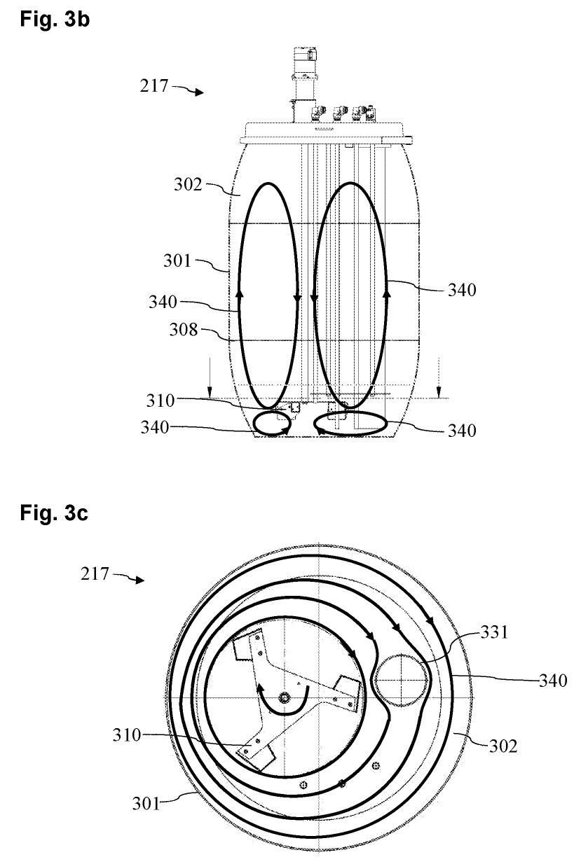

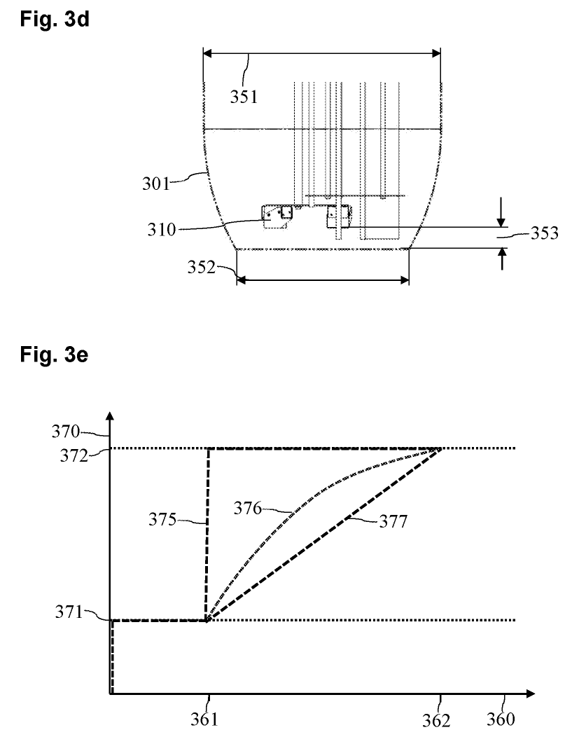

The ink container 217 shown in FIG. 3a has a container wall 301 that encloses a receptacle region 302 for receiving ink 202. The ink container 217 can be covered by a lid 303. The ink container 217 can have the form of a cylinder, in particular a hollow circular cylinder, and/or a vat, that is arranged around a vertically traveling central axis 305.

The ink container 217 has at least one inflow conduit 321 via which ink 202 can be conducted into the receptacle region 302 of the ink container 217. The inflow conduit 321 can extend in the vertical direction from the lid 303 toward the floor of the ink container 217. The end of the inflow conduit 321, i.e. the inflow location of the inflow conduit 321, is preferably arranged relatively close to the floor of the ink container 217, for example at a height of 20% or less of the total height of the ink container 217, in order to prevent ink 202 from dropping into the ink container 217 and thereby forming foam, since inks typically contain surfactants. The ink container 217 can, for example, have a minimum fill level 308 below which the fill level of ink 202 should not fall. The end of the inflow conduit 321, i.e. the inflow location, is preferably arranged below the minimum fill level 308, so that the end of the inflow conduit 321 is always immersed in the ink 202 accommodated by the ink container 217.

Furthermore, the ink container 217 has one or more outflow conduits 322 via which ink 202 can be respectively drawn from the ink container 217. An outflow conduit 322 can extend vertically from an end facing toward the floor, i.e. from an outflow location, up to the lid 303 of the ink container 217. The end of an outflow conduit 322 that faces toward the floor, i.e. the outflow location of the outflow conduit 322, is preferably arranged closer to the floor of the ink container 217 than the end of an inflow conduit 321 that faces toward the floor, i.e. than the inflow location of an inflow conduit 321. The ends of the two conduits 321, 322 can thus have a defined separation 323 from one another along the vertical direction. For example, the separation 323 can be 5% of the total height of the ink container 217. An extraction of homogeneous ink 202 from the ink container 217 can thus be efficiently effected.

The one or more inflow conduits 321 and/or the one or more outflow conduits 322 can be fixed in the ink container 217 by a retaining structure 325, 326 of said ink container 217. The retaining structure 325, 326 can, for example, have a retaining plate 325 that is attached via a plurality of rods 326 to the lid 303 and/or to the upper edge of the ink container 217, and that is preferably arranged at the end of the one or more inflow conduits 321 that faces toward the floor.

The ink container 217 can also have a fill level sensor 330 that is designed to acquire measured values with regard to the fill level of the ink 202 in the ink container 217. The fill level sensor 330 can comprise an ultrasonic sensor. The ink container 217 can also have a meter tube 331 that extends vertically starting from the lid 303 toward the floor of the ink container 217, without contacting the floor of the ink container 217. The meter tube 331 is preferably designed such that the fill level of the ink 202 within the meter rube 331 and the fill level of the ink 202 outside of the meter tube 331 but within the ink container 217 are identical. The fill level sensor 330 can be configured to acquire measured values with regard to the fill level of the ink 202 within the meter tube 331. The fill level can thus be especially precisely detected since currents and/or waves of the ink 202 within the ink container 217 that, for example, are caused by the suppling and/or the mixing of ink 202 are shielded by the meter tube 331. Should foam nevertheless form in the ink container 217, it is prevented by the meter tube 331 that the foam propagates therein. This is advantageous in particular since the measuring sensor 330 can thereby deliver correct and exact fill level values.

The ink container 217 also has a mixing element 310 that is arranged relatively close to the floor of the ink container 217 and that is designed to mix the ink 202 arranged in the ink container 217. In the example depicted in FIG. 3a, the mixing element 310 has a scoop mixer with a plurality of scoops. The mixing element 310 is driven by a motor 311, generally speaking by a drive, that is preferably arranged outside of the ink container 217, in particular above the lid 303. The mixing element 310 is connected with the motor 311 via a drive shaft 312 running in the vertical direction, so that the mixing element 310 is driven by the motor 311 to rotate about the drive shaft 312. The drive shaft 312 can thus correspond to the rotation axis of the mixing element 310.

As is shown in FIG. 3b, a flow 340 of ink 202 within the ink container 217 is effected by the mixing element 310, via which a mixing of the ink 202 within the ink container 217 is achieved. The flow 340 can have a vertical flow component so that ink 202 from the lower region of the ink container 217 is mixed with ink 202 from the upper region of the ink container 217. Alternatively or additionally, the flow 340 can have a horizontal flow component so that respective ink 202 is mixed on at least one horizontally arranged plane of the ink container 217.

The horizontal component of the flow 340 that is caused by the mixing element 310 is illustrated in FIG. 3c. It is thereby also apparent that a flow resistance for the horizontal component of the ink flow 340 is formed by the meter tube 331, wherein an improved mixing of the ink 202 within the ink container 217 is effected due to the flow resistance, since the laminar flow is accordingly disrupted. The more eddies that arise in the fluid, the better the mixing.

The rotation direction of the mixing element 310, and the direction of the horizontal component of the ink flow 340 that is thereby produced, is preferably such that the ink 202 conducted into the ink container 217 via an inflow conduit 321 must initially execute a circular movement of nearly 360° within the ink container 217 before the ink 202 can be conducted out of the ink container 217 via an outflow conduit 322. For this purpose, the rotation direction of the mixing element 310, as well as the inflow conduit 321 and the outflow conduit 322, can be designed and/or arranged such that the outflow conduit 322 is arranged 40° or less before the inflow conduit 321, relative to the rotation movement of the mixing element 310. Homogeneous ink can thus be especially efficiently and reliably provided at the outflow conduit 322.

The rotation axis of the mixing element 310, which typically travels coaxial to the drive shaft 312, is preferably arranged eccentrically relative to the vertical central axis 305 (with a rotational symmetry) of the ink container 217. The ink container 217 can have a defined diameter 351, in particular a defined maximum diameter, for example in the horizontal direction. The rotation axis can be separated from the central axis 305 by 10% or more of the diameter 351, in particular of the maximum diameter, of the ink container 217 (see FIG. 3d). An especially reliable homogenization of the ink 202 can be effected via the eccentric arrangement of the mixing element 310.

FIG. 3e shows examples of functional correlations 375, 376, 377 between the fill level 370 of the ink container 217 and the rotational velocity 360 of the mixing element 310. The rotational velocity 360 is preferably increased with increasing fill level 370. The increase can thereby be effected in steps, as in correlation 375, or continuously, as in correlations 376, 377. An especially efficient and precise homogenization of the ink 202 can thus be effected without thereby generating foam. In particular, a relatively low rotational velocity 361 can be used given a relatively low fill level 370, for example at the minimum fill level 308, 371. If applicable, the rotation movement of the mixing element 310 can be entirely suppressed if the fill level 370 is less than the minimum fill level 371. Furthermore, the rotational velocity 360 can be increased with increasing fill level 370 until the maximum fill level 372 is reached, for example up to a maximum rotational velocity 362.

The end of an inflow conduit 321 can be arranged, in the vertical direction, directly above the level of the mixing element 310. The supplied ink 202 is thereby initially conducted upward in the vertical direction, through the flow 340 effected by the mixing element 310, before the ink 202 falls again toward the floor. As a result of this, the ink 202 is optimally comprehensively mixed by the flow 340. The ends of the one or more outflow conduits 322 are preferably arranged in proximity to the floor, so that primarily homogenized ink 202 is drawn from the ink container 217.

Even if the one or more inflow conduits 321 and the one or more outflow conduits 322 are situated relatively close to one another, geometrically speaking, the travel of the individual particles of the ink 202 can be significantly increased due to the rotation of the mixing element 310, in that the ink particles are not only moved upward in the vertical direction but rather also are guided around the axis of the mixing element 310, before the ink particles are conveyed out of the ink container 217 again.

By using a mixing element 310, in particular a scoop mixer, and due to the eccentric arrangement of the mixing element 310 and/or of the meter tube 331, the formation of eddies around the rotation axis of the mixing element 310 can be increased, whereby the mixing of the pigment particles is further assisted.

A foaming in the measurement region of the fill level sensor 330 can be reliably avoided by using a meter tube 331 for the measurement of the fill level 370 so that the fill level 370 can be especially precisely recorded, in particular given use of an ultrasonic sensor as a fill level sensor 330. The lower end of the meter tube 331 is preferably arranged in immediate proximity to the floor of the ink container 217, so that the influence of the mixing element 310, in particular of the stirring machine, on the fill level measurement is significantly reduced.

As has already been presented, a retaining structure 325, 326 can be provided to fix the conduits 321, 322 in the lower region of the ink container 217.

A control device 101 of the ink supply system 200 and/or of the printing device 100 and/or of the ink container 217 can be configured to adapt the rotation speed and/or the rotation velocity 360 of the mixing element 310 depending on the fill level 370 of the ink container 217, in particular in order to avoid foaming within the ink container 217.

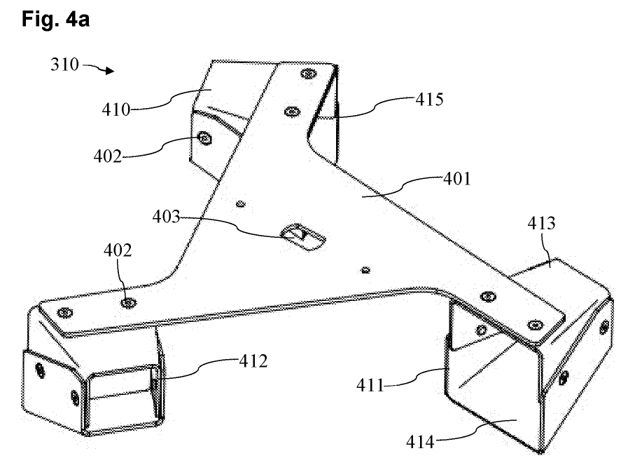

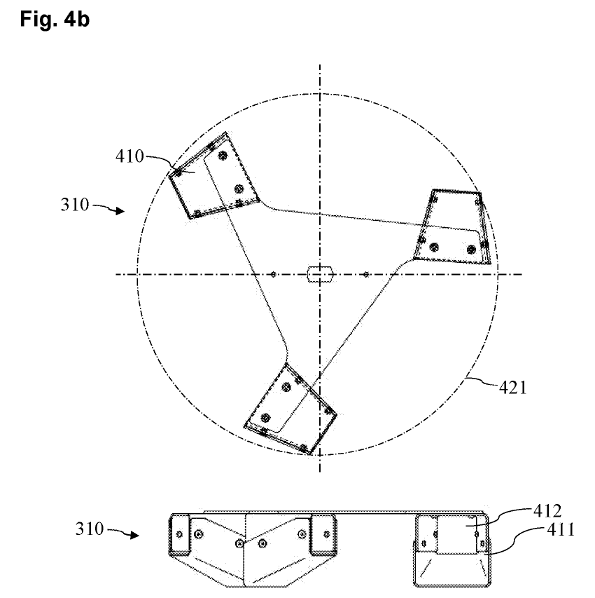

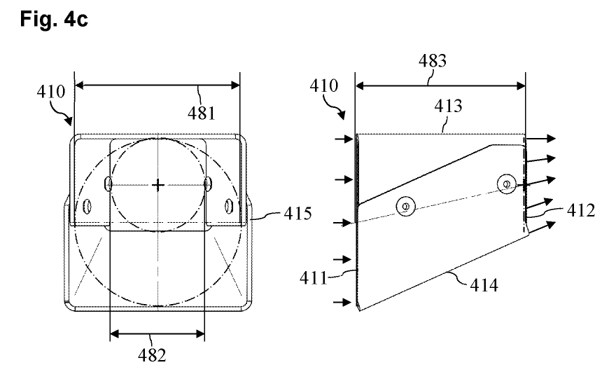

An example of a mixing element 310, in particular an example of a scoop mixer, is depicted in FIGS. 4a-4c. The mixing element 310 comprises a carrier 401, for example a carrier plate, that is designed in order to be rotated about a rotation axis. For this purpose, the carrier 401 can have in a central region of said carrier 401 a central connection point 403 via which the carrier 401 can be attached to the drive shaft 312, so that the carrier 401 is driven by the drive shaft 312 to rotate about the rotation axis. The carrier 401 and/or the mixing element 310 have a defined outer diameter 421.

One or more scoops 410 are attached to the carrier 401, in particular to one or more support arms of the carrier 401, wherein a scoop 410 respectively has an intake opening 411 and an exit opening 412. The intake opening 411 preferably has a larger cross-sectional area than the exit opening 412. The carrier 401 is preferably rotated such that ink 202 flows through the intake opening 411 into a scoop 410, and leaves the scoop 410 again via the exit opening 412.

In the shown example, multiple scoops 410 are attached to the carrier 401, in particular to corresponding support arms of the carrier 401, wherein the scoops 410 and/or the support arms of the carrier 401 are equally distributed in the circumferential direction of the carrier 401. For example, 2 or more or 3 or more scoops 410 can be arranged on the carrier 401. The mixing element 310 can in particular have three scoops 410, as is shown by way of example in FIGS. 4a-4c. The individual scoops 410 can respectively be efficiently attached to the carrier 401 by one or more rivets 402.

A scoop 410 can have an upper scoop wall 413 that travels parallel to the carrier 401, in particular to the carrier plate. The scoop 410 can be attached to the carrier 401 via the upper scoop wall 413, for example using one rivet 402 or a plurality of rivets 402.

Furthermore, a scoop 410 can have a lower scoop wall 414 that travels at an angle to the carrier 410, in particular to the carrier plate. The lower scoop wall 414 can thereby exhibit a greater separation from the upper scoop wall 413 at the intake opening 411 than at the exit opening 412. It can thus be efficiently effected that the intake opening 411 has a larger cross-sectional area than the exit opening 412. Furthermore, via such an oblique, upwardly traveling arrangement of the lower scoop wall 414, it can be effected that a respective vertical, upwardly traveling component of the flow 340 of the ink 202 is effected by the one or more scoops 410 of the mixing element 310, as is represented by way of example by the arrows in FIG. 4c. The pigments contained in the ink preferentially sediment at the floor of a container. The mixing element 310, in particular the lower scoop wall 414, has the effect that the pigments in the ink container 217 are churned upward. The ink is thereby homogenized.

A scoop 410 can be respectively, efficiently composed of sheet metal. The lower scoop wall 414 and a lower part of the side walls 415 of the scoop 410 can thereby be formed by a lower sheet. The upper scoop wall 413 and an upper part of the side walls 415 of the scoop 410 can also be formed by an upper sheet. The lower sheet and the upper sheet can be connected with one another via the side walls 415, for example by one or more rivets, in order to form the scoops 410.

A mixing element 310 is thus described that can be efficiently produced from one or more bent metal sheets that are connected with one another by rivets 402. The surfaces of the sheets can possibly be treated after the joining. The mixing element 310 can have one or more conical scoops 310, wherein the ink 202 is captured by the relatively large intake opening 411 of a scoop 410, and wherein the ink 202 leaves the scoop 410 again via the relatively small exit opening 412 of the respective scoop 410, and thereby exhibits an upwardly directed flow component. It can thus be effected that ink 202 that is arranged above the mixing element 310 in the ink container 217 is also mixed.

The upper wall 413 of a scoop 410 can travel horizontally so that the scoop 410 can be especially efficiently attached to a flat carrier 401, in particular to a carrier plate. Alternatively or additionally, the one or more support arms of the carrier 401 for the corresponding one or more scoops 410 can exhibit a twist about the radial direction, via which the angle of the vertical component of the flow 340 effected by the one or more scoops 410 can be further increased.

In the shown example, the openings 411, 412 of the individual scoops 410 respectively have a quadratic cross section. Alternatively, the intake opening 411 and/or the exit opening 412 of a scoop 410 can have a rectangular or polygonal cross section.

One or more of the following geometric relationships can be used for the mixing element 310, in particular for the stirring machine

the distance 353 (see FIG. 3d) of the mixing element 310 from the floor of the ink container 217 can correspond to the diameter and/or to the width 481 of the intake opening 411 of a scoop 410 of the mixing element 310;
the diameter 421 of the mixing element 310 can, for example, amount to between 0.4 and 0.5 times the maximum diameter 351 of the ink container 217; the diameter 352 of the floor of the ink container 217 is thereby typically smaller than the maximum diameter 351 of the ink container 217;
the hydraulic diameter, in particular the width, 481 of the intake opening 411 of a scoop 410 can be between 0.15 and 0.25 times, in particular can be 0.19 times, the diameter 421 of the mixing element 310;
the hydraulic diameter, in particular the width, 482 of the intake opening 412 of a scoop 410 can be between 0.4 and 0.7 times, in particular can be 0.56 times, the hydraulic diameter, in particular the width, 481 of the intake opening 411;
the length 483 of a scoop 410 in the circumferential direction can be between 0.7 and 1.5 times, in particular can be 1.0 times, the width or the diameter 481 of the scoop 410.

Rivets can be particularly efficiently used to connect the individual sheet metal parts, which rivets are generated by, for example, punching and/or laser cutting. Alternatively, the sheet metal parts can be connected with one another via spot welding and/or via bolting.

An ink container 217 to accommodate ink 202 is thus described for an inkjet printing device 100. The ink container 217 can be part of an ink supply system 200 of the printing device 100. The ink container 217 comprises a container floor and a container wall 301 that together form a receptacle region 302 for ink 202. The receptacle region 302 can in particular be in the shape of a barrel and/or a hollow cylinder. The container wall 301 and/or the receptacle region 302 can be rotationally symmetrical with respect to a central axis 305 traveling in the vertical direction. The receptacle region 302 can also have a circular cylindrical cross-sectional area orthogonal to the vertical direction. The receptacle region 302 of the ink container 217 can be designed to accommodate 10 liters or more, in particular 50 liters or more (in particular at minimum 200 liters) of ink 202.

The container wall 301 can extend in the vertical direction from the container wall to an upper edge. A lid 303 can be arranged at the upper edge of the container wall 301, which lid 303 covers the receptacle region 302 of the ink container 217. The ink container 217 can thus have a lid 303 that is arranged on the upper edge of the container wall 301, said upper edge facing away from the container floor, and that is designed to cover the ink container 217.

The ink container 217 can have at least one inflow conduit 321 for the inflow of ink 202 in the receptacle region 302 of the ink container 217. The inflow conduit 321 can extend in the vertical direction from the lid 303 to an inflow location at which ink 202 is conducted via the inflow conduit 321 into the receptacle region 302 of the ink container 217. The inflow location can correspond to the end of the inflow conduit 321, which is arranged in the receptacle region 302 of the ink container 217. The inflow location is preferably situated lower than the minimum fill level 308, 371 of the ink container 217.

The ink container 217 can also comprise at least one outflow conduit 322 for drawing ink 202 from the receptacle region 302 of the ink container 217. The outflow conduit 322 can extend in the vertical direction from an outflow location up to the lid 303. The outflow location can correspond to the end of the outflow conduit 322, which is arranged in the receptacle region 302 of the ink container 217. The outflow location is preferably situated lower than the minimum fill level 308, 371 of the ink container 217. Ink 202 can be conducted via the conduit 219 and via the inflow conduit 321 into the ink container 217. Furthermore, ink 202 can be drawn by a pump 218 from the ink container 217 via the outflow conduit 322.

In a preferred example, the inflow location of the inflow conduit 321 and the outflow location of the outflow conduit 322 are respectively spaced apart from the container floor by at most 20% or less of the total height of the ink container 217. The total height of the ink container 217 can extend from the container floor up to the upper edge of the container wall 301 of the ink container 217. The outflow location is especially preferably arranged closer to the container floor than the inflow location. For example, the outflow location can be arranged closer, by 5% or more of the total height of the ink container 217, to the container floor than the inflow location. Via a supply and/or discharge of ink 202 proximal to the floor, it can be efficiently effected that homogeneous ink 202 for the printing operation of the printing device 100 is provided from the ink container 217.

The ink container 217 also comprises a mixing element 310 that is designed to mix ink 202 arranged in the receptacle region 302 of the ink container 217. The mixing element 310 can be designed to be rotated about a rotation axis traveling in the vertical direction, in order to produce the flow 340 of ink 202 in the receptacle region 302 of the ink container 217. The ink container 217 can have a drive 311, in particular an electric motor, that is designed to drive the mixing element 317 via a drive shaft 312 to a rotation about said drive shaft 312. The drive shaft 312 can correspond to the rotation axis of the mixing element 310. The drive 311 can be arranged at the lid 303 or above the lid 303 of the ink container 217. The drive shaft 312 can extend in the vertical direction from the drive 311 to the mixing element 310.

In a preferred example, the mixing element 310 is spaced apart from the container floor by at most 20% or less of the total height of the ink container 217. Via a mixing of the ink 202 proximal to the floor, it can be efficiently effected that homogeneous ink 202 is provided from the ink container 217 for the printing operation of the printing device 100.

The mixing element 310 can comprise a scoop mixer. Alternatively or additionally, the mixing element 310 can comprise one or more scoops 410 that are respectively designed to receive ink 202 so that a flow 340 of the ink 202 arranged in the receptacle region 302 of the ink container 217 is effected by the one or more scoops 410. The mixing element 310 can in particular be designed as in this document in order to especially efficiently effect homogenization of the ink 202 in the ink container 217.

The inflow conduit 321 can be designed to conduct ink 202 at an inflow location into the receptacle region 302 of the ink container 217, wherein the inflow location is arranged at the same height as or above the mixing element 310, with respect to the vertical direction. It can thus be efficiently effected that ink 202 that is supplied to the ink container 217 is mixed and thereby homogenized.

The mixing element 310 can be designed to produce a flow 340 of ink 202 in the receptacle region 302 of the ink container 217, which flow has a flow component that is directed vertically upward. Alternatively or additionally, the mixing element 310 can be designed to produce a flow 340 of ink 202 in the receptacle region 302 of the ink container 217 that has a flow component circulating horizontally around the mixing element 310 in the circumferential direction. In a preferred embodiment, the flow 340 produced by the mixing element 310 has a flow component directed vertically upward and a flow component traveling horizontally in the circumferential direction. The flow 340 can have an effective flow direction that is composed of the vertical flow component and the horizontal flow component. The flow 340 can have a defined total magnitude, i.e. a defined effective flow velocity, along the effective flow direction. The magnitude of the vertical flow component, i.e. the flow velocity in the vertical direction, and/or the magnitude of the horizontal flow component, i.e. the flow velocity in the horizontal flow direction, preferably respectively correspond to at least 10% or at least 20% of the total magnitude. A particularly reliably and efficient mixing of the ink 202 to homogenize said ink 202 can be effected by producing such a flow 340 of ink 202 within the ink container 217.

The outflow location at which ink 202 is conducted from the receptacle region 302 of the ink container 217 via the outflow conduit 322 can be arranged below the mixing element 310, with respect to the vertical direction. It can thus be especially efficiently and reliably effected that homogeneous ink 202 is drawn from the ink container 217.

The outflow location at which ink 202 is conducted out of the receptacle region 302 of the ink container 217 via the outflow conduit 322 is arranged after the inflow location, with respect to the circumferential direction, by 320° or more and by less than 360°. It can thus be effected that ink 202 supplied via the inflow location must initially perform nearly a complete circulation around the mixing element 310 before the ink 202 is conducted out of the ink container 217 again via the outflow conduit 322. It can thus be especially efficiently and reliably effected that homogeneous ink 202 is drawn from the ink container 217.

The rotation axis of the mixing element 310 can be arranged eccentrically relative to the central axis 305 of the ink container 217, said central axis 305 traveling in the vertical direction. The rotation axis of the mixing element 310 is preferably separated from the central axis 305 by 10% or more of the diameter 351 of the ink container 217, in particular of the maximum diameter of the ink container 217. An especially reliable mixing of the ink 202 to homogenize the ink 202 can be effected via an eccentric arrangement of the mixing element 310.

The ink container 217 can comprise a meter tube 331 that extends in the vertical direction from the upper edge of the container wall 301 to the container floor. The meter tube 331 can be used to measure the fill level 370 of ink 202 in the receptacle region 302 of the ink container 217. Furthermore, the meter tube 331 can be designed as a flow resistance for the flow 340 of ink 202 in the receptacle region 302 of the ink container 217, said flow being produced by the mixing element 310. The homogenization of the ink 202 can be further improved by providing an additional flow resistance.

The meter tube 331 can be designed such that the fill level 370 of ink 202 in the meter tube 331, and the fill level 370 of ink 202 outside of the meter tube 331 but still within the receptacle region 302 of the ink container 217, are identical in the absence of a flow 340 of ink 202, said flow 340 being produced by the mixing element 310. For this purpose, the end of the meter tube 331 that is arranged in the receptacle region 302 can be spaced apart from the container floor. For example, the end of the meter tube 331 can be spaced apart from the container floor by 2% or more of the total height of the container wall 301, and/or by 20% or less or by 10% or less of the total height of the container wall 301.

The ink container 217 can comprise a fill level sensor 330 that is configured to detect measured values with regard to the fill level 370 of ink 202 within the meter tube 331. The fill level sensor 330 can be arranged at the lid 303 of the ink container 217. The fill level sensor 330 can comprise an ultrasonic sensor. An especially reliable measurement of the fill level 370 of ink 202 in the receptacle region 320 of the ink container 217 can be effected via the measurement of the fill level 370 within the meter tube 331.

The ink container 217 can comprise a control device 101 that is designed to determine fill level information with regard to the fill level 370 of ink 202 in the receptacle region 302 of the ink container 217. The fill level information can be determined using the fill level sensor 330.

The control device 101 can also be configured to induce the mixing element 310 to vary the flow velocity of the flow 340 of ink 202 in the receptacle region 302 of the ink container 217 depending on the fill level information, in particular due to a change in the rotational velocity 360 of the mixing element 310. The flow velocity can thereby be increased with rising fill level 370, in particular by adapting the rotational velocity 360, and/or be reduced with falling fill level 370. A homogenization of the ink 202 can be especially efficiently and reliably effected via a fill level-dependent adaptation of the rotational velocity.

Furthermore, in this document a mixing element 310 for mixing ink 202 is described, in particular a stirring machine, which ink 202 is arranged in an ink container 217 of an ink supply system 200 for an inkjet printing device 100. The mixing element 310 can comprise a carrier 401, in particular a plate-shaped carrier 401, that is designed to be rotated about a rotation axis. The rotation axis can travel in the vertical direction if the mixing element 310 is arranged in the ink container 217. The carrier 401 can be formed by a sheet metal part, in particular by a metal sheet, and/or can be designed as a sheet metal part. The carrier 410 can have a central region at which the rotation axis is arranged. Starting from the central region, one or more support arms can extend in a radial direction away from the central region.

The mixing element 310 can have at least one scoop 410 attached to a support arm of the carrier 401. The mixing element 310 can in particular have a respective scoop 410 at each of the support arms. In a preferred embodiment, the mixing element 310 has two or more, or three or more, scoops 410 that can respectively be attached to a support arm of the carrier 401.

The one or more scoops 410 can respectively be separated from the rotation axis in a radial direction so that the respective scoop 410 is directed in the circumferential direction about the rotation axis given a rotation of the carrier 401. The spacing of the one or more scoops 410 from the rotation axis of the mixing element 310 can depend on the diameter 351, in particular the maximum diameter, of the ink container 217 in which the mixing element 310 is used. The ink container 217 can, for example, have a defined total diameter 351, for example a defined maximum diameter. The mixing element 310 can have a diameter 421 with a value of between 0.4 and 0.5 times the total diameter 351 of the ink container 217. The spacing of the one or more scoops 410 from the rotation axis of the mixing element 310 can correspond to half of the diameter 421 of the mixing element 310. An especially reliable homogenization of ink 202 in the ink container 217 can be effected via such a dimensioning of the mixing element 310.

A scoop 410 can respectively have an intake opening 411 through which ink 202 is conducted into the scoop 410 upon a rotation of the carrier 401. Furthermore, the scoop 410 can have an exit opening 412 via which ink 202 is conducted out of the scoop 410 upon a rotation of the carrier 401. The intake opening 411 and/or the exit opening 412 respectively, preferably have a polygonal cross-sectional area, for example a rectangular cross-sectional area. An especially efficient manufacturing of the one or more scoops 410 can thus be enabled. In particular, it can thus be enabled that the one or more scoops 410 can respectively be manufactured efficiently from one or more sheet metal parts.

A scoop 410 can have an upper scoop wall 413 and a lower scoop wall 414. The terms “upper” and “lower” thereby refer to the typical arrangement of the mixing element 410 in an ink container 217. The upper scoop wall 413 and the lower scoop wall 414 can respectively be formed by a sheet metal part, i.e. respectively by a metal sheet, wherein the sheet metal parts are joined with one another in order to form the scoop 410. The joining of the sheet metal parts can be effected efficiently via one or more rivets 402 or via spot welding. The upper scoop wall 413 and an upper part of the side walls 415 of the scoop 410 can be formed by an upper sheet metal part. The lower scoop wall 414 and a lower part of the side walls 415 of the scoop 410 can be formed by a lower sheet metal part. The two sheet metal parts can be joined with one another, for example be riveted or welded, via the side walls 415.

A leading edge (relative to the rotation movement of the mixing element 310) of the upper scoop wall 413, the side walls 415, and the lower scoop wall 414 can bound the intake opening 411 of the scoop 410. A trailing edge (relative to the rotation movement of the mixing element 310) of the upper scoop wall 413, the side walls 415, and the lower scoop wall 414 can bound the exit opening 412 of the scoop 410. The cross-sectional areas of the intake opening 411 and/or of the exit opening 412 can thus be respectively bounded by the scoop walls 413, 414, 415.

The upper scoop wall 413 of a scoop 410 preferably travels parallel to the support arm of the carrier 401 to which the scoop 410 is attached, in particular is riveted or welded. An efficient joining of the scoop 410 to the carrier 401, in particular a plate-shaped carrier 401, can thus be effected.

On the other hand, the lower scoop wall 414 of the scoop 410 preferably travels in the circumferential direction oblique to the support arm to which the scoop 410 is attached. In particular, the lower scoop wall 414 can run, starting from the intake opening 411, toward the upper scoop wall 413 along the circumferential direction. The upper scoop wall 413 and the lower scoop wall 414 can thereby form an angle with a value of 5° or more and/or of 45° or less relative to the circumferential direction. Via the inclination of the lower scoop wall 414, it can be efficiently effected that the intake opening 411 of the scoop 410 has a larger cross-sectional area than the exit opening 412 of the scoop 410, whereby a reliable mixing and homogenization of ink 202 is effected in turn. Furthermore, a vertical flow component of the flow 340 of ink 202 can be efficiently effected via the inclination of the lower scoop wall 414.

The one or more support arms can be respectively twisted, in particular be twisted by 2° or more, with respect to the radial direction relative to the central region. It can thus be effected that the upper scoop wall 413 at the exit opening 412, i.e. that the trailing edge of the upper scoop wall 413, is higher relative to the rotation axis than at the intake opening 411, i.e. than at the trailing edge of the upper scoop wall 413. As a result of this, the magnitude of the vertical flow component of the flow 340 of ink 202 that is effected by the mixing element 310 in the ink container 217 can be efficiently increased, whereby the homogenization of the ink 202 can in turn be improved.

As has already been presented, the mixing element 310 can have a defined diameter 421 in the radial direction. The intake opening 411 of the scoop 410 can have a width 481 in the radial direction with a value of between 0.15 and 0.25 times, for example with a value of 0.19 times, the diameter 421 of the mixing element 310.

Alternatively or additionally, the width 481 of the exit opening 412 of the scoop 410 can, in the radial direction, have a value of between 0.4 and 0.7 times, in particular a value of 0.56 times, the width 481 of the intake opening 411 of the scoop 410 in the radial direction.

Alternatively or additionally, the length 483 of the scoop 410 can have, in the circumferential direction, a value of between 0.7 and 1.5 times, in particular a value of 1 times, the value 481 of the intake opening 411 of the scoop 410 in the radial direction.

An especially reliable mixing and/or homogenization of ink 202 can be effected via one or more of the aforementioned dimensionings.

Moreover, in this document an ink supply system 200 and/or a printing device 100 are described that respectively comprise at least one ink container 217 that is designed as described in this document.

### REFERENCE LIST

1 transport direction (of the recording medium)

21, 22 nozzle

31, 32 column (of the print image)

100 printing device

101 control device

102 print bar

103 print head

120 recording medium

140 print group

200 ink supply system

201 reservoir

202 ink

209 connecting element

212 filter unit

214 pump

217 ink container (intermediate container)

218 pump

219 conduit

301 container wall

302 receptacle region (ink container)

303 lid

305 vertical central axis

308 minimum fill level

310 mixing element

311 drive (motor)

312 drive shaft

321 inflow conduit

322 outflow conduit

323 spacing

325 retaining plate (retaining structure)

326 rod (retaining structure)

330 fill level sensor

331 meter tube

340 flow (ink)

351 diameter (ink container)

352 diameter (floor of the ink container)

353 spacing (mixing element to floor)

360 rotational velocity

361 first velocity

362 second velocity

370 fill level

371 minimum fill level

372 maximum fill level

375-377 functional correlation

401 carrier (mixing element)

402 rivet

403 connection location

410 scoop

411 intake opening

412 exit opening

413 upper scoop wall

414 lower scoop wall

415 side wall

421 diameter

481 diameter / width (intake opening)

482 diameter / width (exit opening)

483 length (scoop)

1. A mixing element for mixing ink that is arranged in an ink container of an ink supply system for an inkjet printing device, the mixing element comprising:
a carrier configured to be rotated around a rotation axis;
at least one scoop attached to a support arm of the carrier;
the scoop is spaced apart from the rotation axis in a radial direction so that the scoop is directed in a circumferential direction around the rotation axis upon a rotation of the carrier;
the scoop comprising an intake opening through which ink is conducted into the scoop upon rotation of the carrier;
the scoop comprising an exit opening through which ink is conducted out of the scoop upon rotation of the carrier;
the scoop comprising an upper scoop wall that runs parallel to the support arm;
the scoop is configured to be attached to the support arm with the upper scoop wall; and
the scoop comprising a lower scoop wall that runs oblique to the support arm in the circumferential direction, so that the intake opening of the scoop has a larger cross-sectional area than the exit opening of the scoop.

2. The mixing element according to claim 1, wherein the upper scoop wall and the lower scoop wall are respectively formed by a sheet metal part, which sheet metal parts are joined with one another in order to form the scoop.

3. The mixing element according to claim 1, wherein the carrier is formed by a sheet metal part.

4. The mixing element according to claim 1, wherein the scoop is joined with the carrier by one or more rivets.

5. The mixing element according to claim 1, wherein
the carrier has a central region from which the support arm extends in the radial direction;
the support arm is twisted relative to a central region with respect to the radial direction so that the upper scoop wall is higher at the exit opening than at the intake opening, with respect to the rotation axis.

6. The mixing element according to claim 5, wherein
the support arm is twisted relative to the central region by an angle of 2° or more with respect to the radial direction.

7. The mixing element according to claim 1, wherein
the mixing element has a defined diameter in the radial direction; and
the intake opening of the scoop has a width in the radial direction with a value of between 0.15 and 0.25 times the diameter of the mixing element.

8. The mixing element according to claim 1, wherein a width of the exit opening of the scoop in the radial direction has a value of between 0.4 and 0.7 times a width of the intake opening of the scoop in the radial direction.

9. The mixing element according to claim 1, wherein a length of the scoop in the circumferential direction has a value of between 0.7 and 1.5 times a width of the intake opening of the scoop in the radial direction.

10. An ink container to accommodate ink for an inkjet printing device; wherein the ink container comprises
a container floor and a container wall that form a receptacle region for ink;
at least one outflow conduit for drawing ink from the receptacle region of the ink container; and
the mixing element in accordance with claim 1, wherein the mixing element is configured to mix ink arranged in the receptacle region of the ink container.

11. The ink container according to claim 10, wherein
the ink container has a defined total diameter; and
the mixing element has a diameter with a value of between 0.4 and 0.5 times the total diameter of the ink container.

12. An ink supply system configured to supply one or more print heads of a print bar of a printing device with ink, the ink supply system comprising:
an ink reservoir configured to store ink and comprising a connecting element;
a conduit connected at the connecting element of the ink reservoir;
an intermediate container 217 configured to supply ink to the one or more print heads of the print bar; and
a pump arranged at the conduit that is configured to pump ink out of the ink reservoir,
wherein the intermediate container comprises a mixing element comprising:
a carrier configured to be rotated around a rotation axis;
at least one scoop attached to a support arm of the carrier;
the scoop is spaced apart from the rotation axis in a radial direction so that the scoop is directed in a circumferential direction around the rotation axis upon a rotation of the carrier;
the scoop comprising an intake opening through which ink is conducted into the scoop upon rotation of the carrier;
the scoop comprising an exit opening through which ink is conducted out of the scoop upon rotation of the carrier;
the scoop comprising an upper scoop wall that runs parallel to the support arm;
the scoop is configured to be attached to the support arm with the upper scoop wall; and
the scoop comprising a lower scoop wall that runs oblique to the support arm in the circumferential direction, so that the intake opening of the scoop has a larger cross-sectional area than the exit opening of the scoop.

13. The ink supply system according to claim 12, wherein the upper scoop wall and the lower scoop wall are respectively formed by a sheet metal part, which sheet metal parts are joined with one another in order to form the scoop.

14. The ink supply system according to claim 12, wherein the carrier is formed by a sheet metal part.

15. The ink supply system according to claim 12, wherein the scoop is joined with the carrier by one or more rivets.

16. The ink supply system according to claim 12, wherein
the carrier has a central region from which the support arm extends in the radial direction;
the support arm is twisted relative to a central region with respect to the radial direction so that the upper scoop wall is higher at the exit opening than at the intake opening, with respect to the rotation axis.

17. The ink supply system according to claim 16, wherein
the support arm is twisted relative to the central region by an angle of 2° or more with respect to the radial direction.

18. The ink supply system according to claim 12, wherein
the mixing element has a defined diameter in the radial direction; and
the intake opening of the scoop has a width in the radial direction with a value of between 0.15 and 0.25 times the diameter of the mixing element.

19. The ink supply system according to claim 12, wherein a width of the exit opening of the scoop in the radial direction has a value of between 0.4 and 0.7 times a width of the intake opening of the scoop in the radial direction.

20. The ink supply system according to claim 12, wherein a length of the scoop in the circumferential direction has a value of between 0.7 and 1.5 times a width of the intake opening of the scoop in the radial direction.
